(19) United States
(12) Patent Application Publication
(10) Pub. No.: US 2024/0190091 A1
(43) Pub. Date: Jun. 13, 2024

(54) SUBSEA PIPELINE MAINTENANCE ENHANCING DEVICE AND APPLICATION METHOD THEREOF

(71) Applicant: JIANGSU UNIVERSITY OF SCIENCE AND TECHNOLOGY, Zhenjiang (CN)

(72) Inventors: Yongmei ZHU, Zhenjiang (CN); Hongzhang PAN, Zhenjiang (CN); Jian ZHANG, Zhenjiang (CN); Shijie SU, Zhenjiang (CN); Suzhou ZHANG, Zhenjiang (CN); Chuxiang LIN, Zhenjiang (CN)

(73) Assignee: JIANGSU UNIVERSITY OF SCIENCE AND TECHNOLOGY, Zhenjiang (CN)

(21) Appl. No.: 18/413,113

(22) Filed: Jan. 16, 2024

Related U.S. Application Data
(63) Continuation of application No. PCT/CN2023/084226, filed on Mar. 28, 2023.

(30) Foreign Application Priority Data
Mar. 22, 2023 (CN) 202310287009.4

(51) Int. Cl. B29C 73/12

(52) U.S. Cl. CPC B29C 73/12

(57) ABSTRACT

A device includes a water storage tank, a control cabin and an operation cabin which are sequentially connected from top to bottom, the operation cabin includes a sealing zone and an operation zone, the sealing zone is located on an inner wall of the operation cabin, a pressure difference between an internal pressure and an external pressure is adjusted to make the maintenance enhancing device separated from or absorbed on a subsea pipeline, and the operation zone is located between the sealing zone and the subsea pipeline.

### CROSS-REFERENCE TO RELATED APPLICATIONS

This application is the U.S. continuation application of International Application No. PCT/CN2023/084226 filed on 28 Mar. 2023 which designated the U.S. and claims priority to Chinese Application No. CN202310287009.4 filed on 22 Mar. 2023, the entire contents of each of which are hereby incorporated by reference.

### TECHNICAL FIELD

The present disclosure relates to the field of pipeline maintenance, and particularly relates to a subsea pipeline maintenance enhancing device and an application method thereof.

### BACKGROUND

With the advancement of science and technologies, domestic offshore oil and gas field development heads for the deep water. Human needs for the development and exploration of ocean resources become increasingly urgent. The exploitation and utilization of ocean mineral resources often need offshore oil drilling platforms and submarine oil and gas transport pipelines. A rated working pressure of a high-pressure manifold can generally reach 35-140 MPa. Because of a high working pressure, the manifold may burst to leak, resulting in ocean pollution. A subsea pipeline maintenance enhancing device is mainly used for enhancing the repair and maintenance of oil pipeline equipment and guaranteeing that the oil pipeline equipment always has a high-quality level, thereby effectively prolonging the service life of oil pipelines.

However, in the field of oil pipelines, an existing maintenance device and method have the following disadvantages: (1) in the prior art, oil pipelines are maintained after the leakage occurs, which cannot avoid the ocean pollution caused by oil and gas leakage; oil inside the pipelines need to be emptied, and the device cannot be used during the running process of the pipelines; for example, an oil pipeline maintenance method disclosed in the Chinese patent with the publication number CN108591675B is applied to pipelines to which leakage has occurred, oil in oil pipelines needs to be emptied first, then look for a leakage point, and mark the leakage point for the maintenance of maintenance personnel. (2) the prior art is mostly suitable for the replacement and maintenance of onshore oil and gas pipelines but not subsea pipelines, the subsea pipelines cannot be directly maintained and enhanced under the sea, maintenance costs are high, and risks are high.

### SUMMARY

The present disclosure aims to provide a subsea pipeline maintenance enhancing device which is capable of detecting anomalies and automatically repairing pipelines in the using process of the pipelines and an application method thereof.

The technical solution is as follows: a subsea pipeline maintenance enhancing device according to the present disclosure, comprises a water storage tank, a control cabin and an operation cabin which are sequentially connected from top to bottom, the control cabin controls the water storage tank to be filled with water or drain water to enable the maintenance enhancing device to be submerged or float upward, an outer wall of the control cabin is provided with propellers for controlling the maintenance enhancing device to move, the operation cabin comprises a sealing zone and an operation zone, the sealing zone is located on an inner wall of the operation cabin, the water storage tank is filled with water or drains water to adjust a pressure difference between an internal pressure and an external pressure to enable the maintenance enhancing device to be separated from or absorbed on a subsea pipeline, and the operation zone is located between the sealing zone and the subsea pipeline; the subsea pipeline maintenance enhancing device further comprises a maintenance mechanism, the maintenance mechanism comprises a fiber placement wheel mechanism and a steering wheel mechanism which are arranged in the control cabin, a fiber placement head arranged in the operation cabin and a moving mechanism connected to the fiber placement head, a fiber placement material that penetrates out of the fiber placement wheel mechanism is guided into the fiber placement head via the steering wheel mechanism, and the moving mechanism drives the fiber placement head to move transversely, longitudinally and/or circumferentially to carry out ply repairing.

Preferably, the fiber placement head is arranged in a guide sealed tube perpendicular to a bottom board of the control cabin.

Preferably, the fiber placement head and the moving mechanism are magnetically connected.

Preferably, the moving mechanism comprises longitudinal guide rails arranged on an inner wall of the operation zone of the operation cabin, longitudinal sliding blocks are arranged on the longitudinal guide rails and matched with the longitudinal guide rails to form longitudinal sliding rails, transverse guide rails are connected to the longitudinal sliding blocks, and transverse sliding blocks are arranged on the transverse guide rails and matched with the transverse guide rails to form transverse sliding rails; a circumferential guide rail is connected to the transverse sliding blocks, and a circumferential sliding block is arranged on the circumferential guide rail and matched with the circumferential guide rail to form a circumferential sliding rail.

Preferably, a detection mechanism comprises cameras and ultrasonic monitors which are arranged in the operation cabin.

Preferably, the water storage tank is cylindrical and has high crush resistance.

Preferably, the bottom of the operation cabin is matched with the outline of a pipeline.

Preferably, the subsea pipeline maintenance enhancing device further comprises a power mechanism arranged in the control cabin, and the power mechanism is a lithium battery.

Preferably, a fiber placement material is a carbon fiber which is low in cost, high in seawater corrosion resistance and strength and strong in plasticity.

An application method of the subsea pipeline maintenance enhancing device according to the present disclosure comprises the following steps:
(a) putting the maintenance enhancing device into water, and filling the water storage tank with water to enable the maintenance enhancing device to be submerged; then turning on the propellers, and controlling the maintenance enhancing device to move as a whole;
(b) turning on the detection mechanism to carry out detection along a subsea pipeline; if detecting no defect on the surface of the subsea pipeline, carrying out operations normally, and otherwise, proceeding to the next step;
(c) adjusting the direction and speed of the propellers to enable the bottom of the operation cabin to be aligned with and abut against the defect on the surface of the subsea pipeline;
(d) controlling the sealing zone of the operation cabin to drain water, and carrying out sealing between the maintenance enhancing device and the subsea pipeline using a pressure difference between an internal pressure and an external pressure of the sealing zone and the propellers; controlling the operation zone of the operation cabin to drain water after the operation cabin and the subsea pipeline are sealed;
(e) linking the fiber placement head to the moving mechanism;
(f) heating the fiber placement head to melt the fiber placement material for reshaping, and adjusting the moving mechanism to make the fiber placement head closely attached to a defective area on the surface of the subsea pipeline to carry out ply repairing;
(g) after completing repairing, turning off the fiber placement head to stop heating, adjusting the moving mechanism to its original location, and separating the fiber placement head from the moving mechanism;
(h) filling the sealing zone of the operation cabin with water, and adjusting the speed and direction of the propellers to make the maintenance enhancing device separated from the subsea pipeline;
(i) repeating the steps (b) to (h) to gradually complete the overall maintenance of the subsea pipeline;
(j) controlling the water storage tank to drain water after the maintenance is completed, and adjusting the speed and direction of the propellers to make the maintenance enhancing device smoothly rise to the sea surface.

Compared with the prior art, the present disclosure has the following remarkable advantages: 1. the maintenance enhancing device can detect cracks, corrosion defects, etc. on the surface of a pipeline in advance when the subsea pipeline is in use, carry out automatic repairing and protect the pipeline against corrosion leakage to avoid ocean pollution; 2. in the maintenance process, there is no need to empty the pipeline, and normal running of the pipeline cannot be affected, thereby shortening the maintenance time and improving work efficiency; 3. the maintenance is automatically completed through the device without on-site operations by maintenance personnel, thereby reducing the maintenance risk of oil and gas pipelines and lowering maintenance costs of the oil and gas pipelines; 4. the device is provided with a control platform, through which maintenance work can be carried out automatically, remote control can also be realized through an external platform, and manual control is realized.

### BRIEF DESCRIPTION OF THE DRAWINGS

FIG. 1 is a structural schematic view of the present disclosure;

FIG. 2 is an internal layout view of a control cabin according to the present disclosure;

FIG. 3 is a structural front view of the present disclosure;

FIG. 4 is a sectional view of FIG. 3 in a direction A according to the present disclosure;

FIG. 5 is a sectional view of FIG. 4 in a direction B according to the present disclosure;

FIG. 6 is a structural bottom view of the present disclosure;

FIG. 7 is a view of the principle of a hydraulic system according to the present disclosure;

FIG. 8 is a schematic view of a control platform according to the present disclosure;

FIG. 9 is a structural schematic view of a fiber placement head according to the present disclosure.

### DETAILED DESCRIPTION OF EMBODIMENTS

The technical solution of the present disclosure is described in further detail below in conjunction with the accompanying drawings.

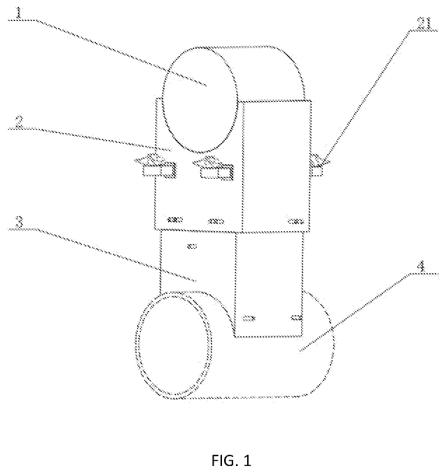

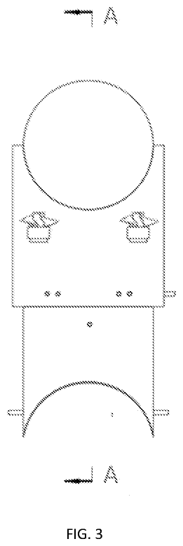

As shown in FIG. 1 and FIG. 3, a subsea pipeline maintenance enhancing device according to the present disclosure includes a water storage tank 1, a control cabin 2 and an operation cabin 3 which are sequentially connected from top to bottom, a water storage tank body is cylindrical and has high crush resistance, and the shape of the bottom of the operation cabin is matched with that of a subsea pipeline 4. The interiors of the water storage tank 1 and the control cabin 2 are sealed and waterproof. The control cabin 2 controls the water storage tank 1 to be filled with water or drain water to enable the maintenance enhancing device to be submerged or float up. An outer wall of the control cabin 2 is provided with propellers 21 for controlling the maintenance enhancing device to move as a whole. The operation cabin 3 includes a sealing zone 34 and an operation zone 35, the sealing zone 34 is located on an inner wall of the operation cabin 3, and the operation zone 35 is located between the sealing zone 34 and the subsea pipeline 4. The control cabin 2 controls the sealing zone 34 to be filled with water or drain water to adjust a pressure difference between an internal pressure and an external pressure to make the maintenance enhancing device separated from or absorbed onto the subsea pipeline 4, thereby facilitating operations in the operation zone 35.

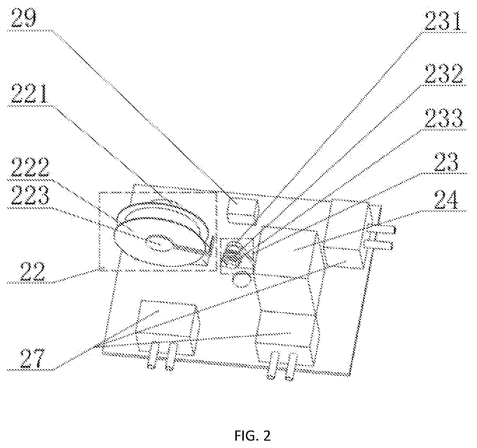

As shown in FIG. 2, a fiber placement wheel mechanism 22, a steering wheel mechanism 23 and a control platform 24 are arranged on a bottom board of the control cabin 2. The fiber placement wheel mechanism 22 includes a fiber placement wheel base 221, a fiber placement wheel 222 and a fiber placement wheel fixed guider 223, the fiber placement wheel base 221 and the fiber placement wheel fixed guider 223 are in bolted connection, and the fiber placement wheel 222 is installed on the fiber placement wheel base 221. The steering wheel mechanism 23 includes a steering wheel base 231, a steering wheel 232 and a steering wheel fixator 233, the steering wheel base 231 and the steering wheel fixator 233 are in bolted connection, and the steering wheel 232 is installed on the steering wheel base 231. A guide sealed tube 25 is perpendicularly arranged on the bottom board of the control cabin, and the guide sealed tube 25 is located inside the operation cabin and is internally provided with a fiber placement head 26.

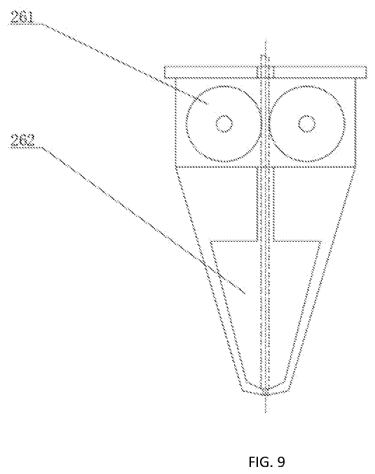

A carbon fiber is used as a fiber placement material, which is low in cost, high in seawater corrosion resistance and strength and strong in plasticity. The carbon fiber on the fiber placement wheel 222 goes through a guide port of the fiber placement wheel fixed guider 223 and is guided into the fiber placement head 26 in the guide sealed tube 25 via the steering wheel 232. The fiber placement head 26 includes fiber feed wheels 261 and a heating melting zone 262. As shown in FIG. 9, after going into the fiber placement head 26, the filiform carbon fiber material is fed into the heating melting zone 262 with the rotation of the fiber feed wheels 261 and melted under a high temperature so that the filiform carbon fiber material is reshaped for ply repairing.

A sea water pump water filling and draining method chosen is more stable compared with a compressed air blowing method. Three high-pressure sea water pump mechanisms 27 are arranged on the bottom board of the control cabin 2 and connected to the water storage tank 1 and the sealing zone 34 and the operation zone 35 of the operation cabin through drain pipes respectively, joints are sealed and waterproof, and the three high-pressure sea water pump mechanisms are used for controlling water draining and water filling of the water storage tank and the sealing zone and the operation zone of the operation cabin.

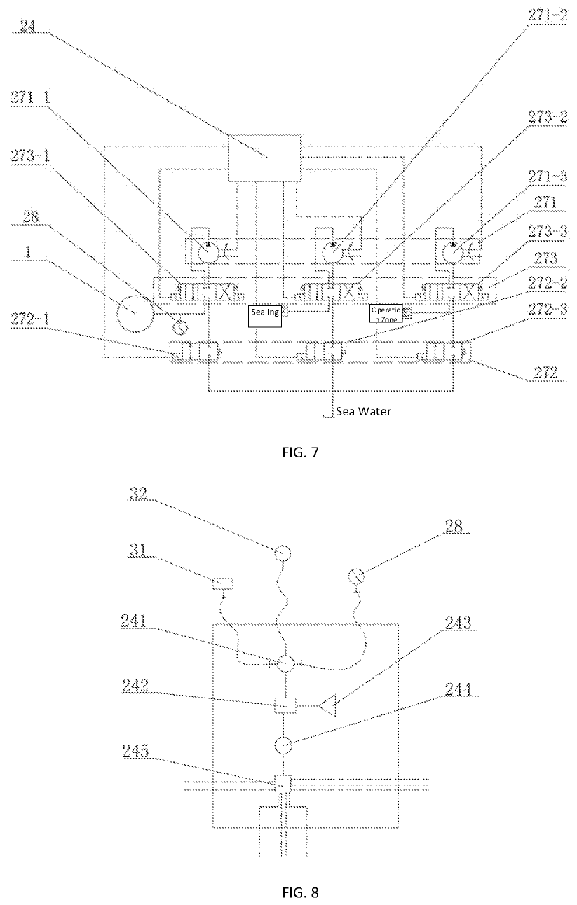

Specifically, as shown in FIGS. 7 to 8, the high-pressure sea water pump mechanism 27 includes a high-pressure sea water pump 271, a high-voltage electromagnetic switch 272 and a high-voltage solenoid valve 273, the control platform 24 includes an A/D converter 241, an industrial control computer 242, a remote sensing transmitter 243, a D/A converter 244 and an actuator 245, where the A/D converter 241 is connected to high-definition cameras 31, ultrasonic monitors 32 and a high-pressure gauge 28, and the actuator 245 is connected to the three high-pressure sea water pump mechanisms 27.

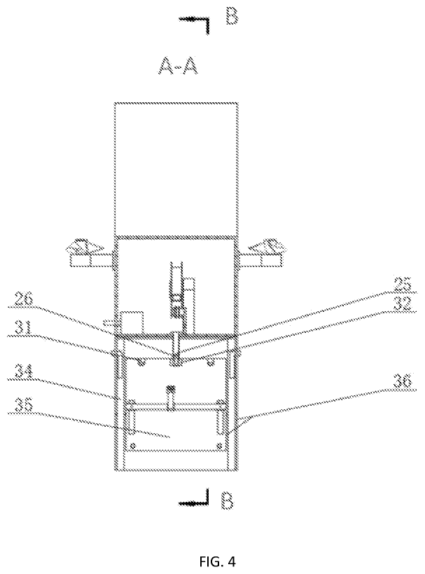

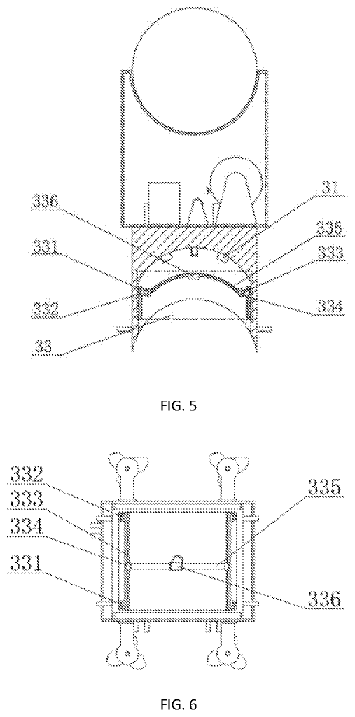

As shown in FIGS. 4 to 6, the high-definition cameras 31, the ultrasonic monitors 32 and the moving mechanism 33 are arranged in the operation zone of the operation cabin 3. The high-definition cameras 31 are arranged at the top of the operation zone 35 and symmetrically distributed close to the sealing zone 34 and are in bolted connection with the operation cabin 3. The ultrasonic monitors 32 are arranged at the top of the operation zone 35 and symmetrically distributed far away from the sealing zone 34 and are in bolted connection with the operation cabin 3.

The moving mechanism 33 comprises longitudinal guide rails 331 arranged on a sidewall of the operation zone of the operation cabin, longitudinal sliding blocks 332 are arranged on the longitudinal guide rails 331 and matched with the longitudinal guide rails to form longitudinal sliding rails, transverse guide rails 333 are connected to the longitudinal sliding blocks 332, and transverse sliding blocks 334 are arranged on the transverse guide rails 333 and matched with the transverse guide rails to form transverse sliding rails; a circumferential guide rail 335 is connected to the transverse sliding blocks 334, and a circumferential sliding block 336 is arranged on the circumferential guide rail 335 and matched with the circumferential guide rail to form a circumferential sliding rail. The fiber placement head 26 is magnetically connected to the circumferential sliding block 336, and the moving mechanism 33 drives the fiber placement head 26 to move transversely, longitudinally and/or circumferentially.

The bottom of the operation cabin 3 is wrapped by a sealing rubber 36, the sealing rubber 36 is in adhesive connection with the bottom of the operation cabin 3, and the sealing rubber has high sealing performance and corrosion resistance and is capable of enhancing the sealing effect of the sealing zone 34.

The maintenance enhancing device is powered by a lithium battery 29 installed in the control cabin. The lithium battery has the advantages of high stored energy, high safety and the like and is suitable for machines for underwater operations.

An application method of the subsea pipeline maintenance enhancing device according to the present disclosure includes the following steps:
(a) putting the maintenance enhancing device into water, controlling, by the control platform 24, an electromagnetic coil of a high-voltage electromagnetic switch I 272-1 to be powered on so that the high-voltage electromagnetic switch I is at a left working position, powering on a left electrode of a high-voltage solenoid valve I 273-1 so that the high-voltage solenoid valve I is at a left working position, turning on a high-pressure sea water pump I 271-1 to fill the water storage tank with water through a drain pipe to enable the maintenance enhancing device to be submerged; turning on the propellers 21 after the maintenance enhancing device is submerged, and controlling the maintenance enhancing device to move as a whole;
(b) turning on the high-definition cameras 31 and the ultrasonic monitors 32 to carry out detection along a subsea pipeline; if detecting no defect on the surface of the subsea pipeline, carrying out operations normally, and otherwise, proceeding to the next step;
(c) adjusting the direction and speed of the propellers 21 to enable the bottom of the operation cabin 3 to be aligned with and abut against the defect on the surface of the subsea pipeline;
(d) controlling, by the control platform 24, an electromagnetic coil of a high-voltage electromagnetic switch II 272-2 to be powered on so that the high-voltage electromagnetic switch II is at a left working position, powering on a right electrode of a high-voltage solenoid valve II 273-2 so that the high-voltage solenoid valve II is at a right working position, turning on a high-pressure sea water pump II 271-2 to drain water in the sealing zone of the operation cabin 3, and carrying out sealing between the maintenance enhancing device and the subsea pipeline through a pressure difference between an internal pressure and an external pressure of the sealing zone and the propellers 21; after the water in the sealing zone is drained, powering off a left electrode of the high-voltage electromagnetic switch II 272-2 so that the high-voltage electromagnetic switch II is at the right working position, powering off the right electrode of a high-voltage solenoid valve II 273-2 so that the high-voltage solenoid valve II is at a neutral position, and turning off the high-pressure sea water pump II 271-2;
(e) controlling, by the control platform 24, an electromagnetic coil of a high-voltage electromagnetic switch III 272-3 to be powered on so that the high-voltage electromagnetic switch III is at a left working position, powering on a right electrode of a high-voltage solenoid valve III 273-3 so that the high-voltage solenoid valve III is at a right working position, turning on a high-pressure sea water pump III 271-3 to drain water in the operation zone of the operation cabin 3; after the water in the operation zone is drained, powering off the electromagnetic coil of the high-voltage electromagnetic switch III 272-3 so that the high-voltage electromagnetic switch is at the right working position, and powering off the right electrode of the high-voltage solenoid valve III 273-3 so that the high-voltage solenoid valve III is at a neutral position;
(f) opening the bottom of the guide sealed tube 25, and magnetically linking the fiber placement head 26 to the circumferential sliding block 336 of the moving mechanism;
(g) heating the fiber placement head to melt the fiber placement material for reshaping, and adjusting the moving mechanism by adjusting the positions of the longitudinal sliding blocks 332, the transverse sliding blocks 334 and the circumferential sliding block 336 through the control platform 24 to make the fiber placement head 26 closely attached to a defective area on an outer surface of the subsea pipeline to carry out ply repairing;
(h) after completing repairing, turning off the fiber placement head 26 to stop heating, adjusting the moving mechanism to its original location, separating the fiber placement head from the moving mechanism, and closing the bottom of the guide sealed tube 25;
(i) powering on the electromagnetic coil of the high-voltage electromagnetic switch III 272-3 so that the high-voltage electromagnetic switch is at a left working position, powering on a left electrode of the high-voltage solenoid valve III 273-3 so that the high-voltage solenoid valve III is at the left working position, turning on the high-pressure sea water pump III 271-3 to fill the operation zone of the operation cabin 3 with water; powering on the left electrode of the high-voltage electromagnetic switch II 272-2 so that the high-voltage electromagnetic switch II is at the left working position, powering on the left electrode of the high-voltage solenoid valve II 273-2 so that the high-voltage solenoid valve II is at the left working position, turning on the high-pressure sea water pump II 271-2 to fill the sealing zone of the operation cabin 3 with water, and adjusting the speed and direction of the propellers 21 to make the maintenance enhancing device separated from the subsea pipeline;
(j) turning off the high-pressure sea water pump III 271-3 and the high-pressure sea water pump II 271-2, powering off the electromagnetic coil of the high-voltage electromagnetic switch III 272-3 so that the high-voltage electromagnetic switch III is at the right working position, and powering off the left electrode of the high-voltage solenoid valve III so that the high-voltage solenoid valve III 273-3 is at the neutral position; powering off the left electrode of the high-voltage electromagnetic switch II 272-2 so that the high-voltage electromagnetic switch II is at the right working position, powering off the left electrode of the high-voltage solenoid valve II 273-2 so that the high-voltage solenoid valve II is at the neutral position, and adjusting the propellers 21 to make the maintenance enhancing device to continue moving along the pipeline;
(k) repeating the steps (b) to (h) to gradually complete the overall maintenance of the subsea pipeline;
(1) after the maintenance is completed, controlling, by the control platform 24, the left electrode of the high-voltage solenoid valve I 273-1 to be powered off and powering on the right electrode so that the high-voltage solenoid valve I is at the right working position, draining the water in the water storage tank 1 by the high-pressure sea water pump I 271-1 to increase the overall buoyancy of the maintenance enhancing device, after the water in the water storage tank 1 is drained, powering off the electrode of the high-voltage electromagnetic switch I 272-1 so that the high-voltage electromagnetic switch I is at the right working position, powering off the right electrode of the high-voltage solenoid valve I 273-1 so that the high-voltage solenoid valve I is at the neutral position, stopping running of the high-pressure sea water pump I 272-1, and adjusting the speed and direction of the propellers to make the maintenance enhancing device rise to the sea surface smoothly.

What is claimed is:

1. A subsea pipeline maintenance enhancing device, comprising a water storage tank (1), a control cabin (2) and an operation cabin (3) which are sequentially connected from top to bottom, wherein the control cabin (2) controls the water storage tank (1) to be filled with water or drain water to enable the maintenance enhancing device to be submerged or float upward, an outer wall of the control cabin (2) is provided with propellers (21) for controlling the maintenance enhancing device to move, the operation cabin (3) comprises a sealing zone (34) and an operation zone (35), the sealing zone (34) is located on an inner wall of the operation cabin (3), a pressure difference between an internal pressure and an external pressure is adjusted to enable the maintenance enhancing device to be separated from or absorbed on a subsea pipeline, and the operation zone (35) is located between the sealing zone (34) and the subsea pipeline (4); further comprising a maintenance mechanism, wherein the maintenance mechanism comprises a fiber placement wheel mechanism (22) and a steering wheel mechanism (23) which are arranged in the control cabin (2), a fiber placement head (26) arranged in the operation cabin (3) and a moving mechanism (33) connected to the fiber placement head, a fiber placement material that penetrates out of the fiber placement wheel mechanism is guided into the fiber placement head via the steering wheel mechanism, and the moving mechanism drives the fiber placement head to move transversely, longitudinally and/or circumferentially to carry out ply repairing.

2. The subsea pipeline maintenance enhancing device according to claim 1, wherein the fiber placement head (26) is arranged in a guide sealed tube (25) perpendicular to a bottom board of the control cabin (2).

3. The subsea pipeline maintenance enhancing device according to claim 2, wherein the fiber placement head (26) and the moving mechanism (33) are magnetically connected.

4. The subsea pipeline maintenance enhancing device according to claim 1, wherein the moving mechanism (33) comprises longitudinal guide rails (331) arranged on an inner wall of the operation zone (35) of the operation cabin, longitudinal sliding blocks (332) are arranged on the longitudinal guide rails (331) and matched with the longitudinal guide rails; transverse guide rails (333) are connected to the longitudinal sliding blocks (332), and transverse sliding blocks (334) are arranged on the transverse guide rails (333) and matched with the transverse guide rails; a circumferential guide rail (335) is connected to the transverse sliding blocks (334), and a circumferential sliding block (336) is arranged on the circumferential guide rail (335) and matched with the circumferential guide rail.

5. The subsea pipeline maintenance enhancing device according to claim 1, wherein a detection mechanism comprises cameras (31) and ultrasonic monitors (32) which are arranged in the operation cabin.

6. The subsea pipeline maintenance enhancing device according to claim 1, wherein the water storage tank (1) is cylindrical.

7. The subsea pipeline maintenance enhancing device according to claim 1, wherein the bottom of the operation cabin (3) is matched with an outline of a pipeline.

8. The subsea pipeline maintenance enhancing device according to claim 1, further comprising a power mechanism (29) arranged in the control cabin, and the power mechanism being a lithium battery.

9. The subsea pipeline maintenance enhancing device according to claim 1, wherein the fiber placement material is a carbon fiber.

10. An application method of the subsea pipeline maintenance enhancing device according to claim 1, comprising the following steps:
(a) putting the maintenance enhancing device into water, and filling the water storage tank with water to enable the maintenance enhancing device to be submerged; then turning on the propellers, and controlling the maintenance enhancing device to move as a whole;
(b) turning on the detection mechanism to carry out detection along a subsea pipeline; if detecting no defect on the surface of the subsea pipeline, carrying out operations normally, and otherwise, proceeding to the next step;
(c) adjusting the direction and speed of the propellers to enable the bottom of the operation cabin to be aligned with and abut against the defect on the surface of the subsea pipeline;
(d) controlling the sealing zone of the operation cabin to drain water, and carrying out sealing between the maintenance enhancing device and the subsea pipeline using a pressure difference between an internal pressure and an external pressure of the sealing zone and the propellers; controlling the operation zone of the operation cabin to drain water after the operation cabin and the subsea pipeline are sealed;
(e) linking the fiber placement head to the moving mechanism;
(f) heating the fiber placement head to melt the fiber placement material for reshaping, and adjusting the moving mechanism to make the fiber placement head closely attached to a defective area on the surface of the subsea pipeline to carry out ply repairing;
(g) after completing repairing, turning off the fiber placement head to stop heating, adjusting the moving mechanism to its original location, and separating the fiber placement head from the moving mechanism;
(h) filling the sealing zone of the operation cabin with water, and adjusting the speed and direction of the propellers to make the maintenance enhancing device separated from the subsea pipeline;
(i) repeating the steps (b) to (h) to gradually complete the overall maintenance of the subsea pipeline;
(j) controlling the water storage tank to drain water after the maintenance is completed, and adjusting the speed and direction of the propellers to make the maintenance enhancing device smoothly rise to the sea surface.
